(19) United States
(12) Patent Application Publication
(10) Pub. No.: US 2017/0218952 A1
(43) Pub. Date: Aug. 3, 2017

(54) DEVICE AND SYSTEM FOR THE PRESSURIZATION OF A FLUID, AND CORRESPONDING USE

(71) Applicant: Robert Bosch GmbH, Stuttgar (DE)

(72) Inventors: Thilo Bareuther, Plochingen (DE); Joachim Goeser, Donzdorf (DE); Martin Maier, Hochdorf (DE); Karl-Martin Kutteruf, Neidlingen (DE); Reinhard Hoss, Plochingen (DE); Dirk Doerhoefer, Owen (DE); Markus Vogel, Albershausen (DE)

(21) Appl. No.: 15/329,745

(22) PCT Filed: Jun. 18, 2015
(86) PCT No.: PCT/EP2015/063686

§ 371 Date: Jan. 27, 2017

(30) Foreign Application Priority Data
Aug. 7, 2014 (DE) 10 2014 215 646.7

(51) Int. Cl. F04C 11/00; F16K 15/02; F04C 2/08

(52) U.S. Cl. CPC F04C 11/003; F04C 2/084; F16K 15/025

(57) ABSTRACT

An apparatus and a system for application of pressure to a fluid, as well as a corresponding use. The apparatus includes an introduction port for introducing the fluid into the apparatus; a cooling apparatus port and an outlet port; a controllable first valve device having an adjustable first opening pressure value; a second valve device having a second opening pressure value; a controllable third valve device having an adjustable third opening pressure value; the first valve device and the third valve device being automatically controllable for simultaneous application to the fluid of the first predefinable pressure value for output at the outlet port and of the second predefinable pressure value for output at the cooling apparatus port.

The present invention relates to an apparatus for application of pressure to a fluid, in particular for automatic application to a fluid of a first predefinable pressure value for output at an outlet port, and of a second predefinable pressure value for output at a cooling apparatus port. In particular, regulation of the pressure of the fluid at the outlet port to the first predefinable pressure value, and regulation of the pressure of the fluid at the cooling apparatus port to the second predefinable pressure, are possible simultaneously. The present invention furthermore relates to a system for automatic application to a fluid of a first predefinable pressure value for output at an outlet port.

The fluid is preferably a liquid, in particular an oil. The fluid can also be a gas, or can be subjected to aggregate state conversions in particular between a liquid and a gas.

### BACKGROUND INFORMATION

The furnishing of a fluid having a predefined pressure value, in particular a predefined pressure course over time, is a frequent requirement. In particular, testing of a test article, for example a high-pressure pump, often requires several changes in the inflow pressure of the oil supply during the testing sequence on a pump test stand. In this context, the “inflow pressure” is that predefinable and predefined pressure value of the fluid, i.e., a numerical pressure value, which is exhibited by the pressure of the fluid that is furnished for testing of the high-pressure pump. An adjustment of the inflow pressure is usually accomplished manually. Manual pressure regulating actions in the inflow are usually made by way of a pressure limiting valve, to be actuated manually, in the tank return line. A closure having a preloaded spring determines the inflow pressure. This is subject, however, to fluctuations upon changes in the volume flow changes, upon changes in the spring preload as a result thereof, and upon modification of openings or throttling. Cooling of the oil used for testing is moreover conventionally accomplished via a separate cooling circuit having a separate supply pump.

German Patent Application No. DE 10 2011 118 282 A1 describes a hydraulic pump test stand having a regulated return feed unit.

### SUMMARY

In accordance with the present invention, an apparatus for application of pressure to a fluid is provided, the fluid being capable of having applied to it a first predefinable pressure value for output at an outlet port and, in particular simultaneously, a second predefinable pressure value for output at a cooling apparatus port. The apparatus includes, for example: an introduction port for introducing the fluid into the apparatus; the cooling apparatus port and the outlet port; a first conduit node that has a first outlet and a second outlet, the fluid introduced at the introduction port being conveyable by way of the first outlet to a controllable first valve device having an adjustable first opening pressure value, and being conveyable by way of the second outlet to a second valve device having a second opening pressure value; the fluid being conveyable via the controllable first valve device to the cooling apparatus port; the fluid being conveyable via the second valve device to a second conduit node having a third outlet and a fourth outlet; the fluid conveyed to the second conduit node being conveyable by way of the third outlet of the second conduit node to a controllable third valve device having an adjustable third opening pressure value; and the fluid conveyed to the second conduit node being conveyable by way of the fourth outlet of the second conduit node to the outlet port; and the first valve device and the third valve device being automatically controllable for simultaneous application to the fluid of the first predefinable pressure value for output at the outlet port and of the second predefinable pressure value for output at the cooling apparatus port. The apparatus thus includes in particular the first and second conduit nodes as well as the first to third valve devices.

Also provided is a system for, in particular automatic, application to a fluid of a first predefinable pressure value for output at an outlet port, having: an apparatus according to the present invention; a controllable first pump apparatus that is connected to the introduction port of the apparatus in order to introduce the fluid; a fluid tank for storing the fluid, which is connected to the apparatus in order to receive fluid to be returned from the apparatus to the fluid tank; and a cooling apparatus, connected at the cooling apparatus port of the apparatus, in which the fluid functions as a coolant and by way of which the fluid is returnable to the fluid tank.

Also provided is a use of the system according to the present invention or of the apparatus according to the present invention for testing an injection pump.

In accordance with the present invention, advantageously, a single supply pump can be used both for a cooling circuit for cooling a test article and/or an injection quantity, and for a supply circuit for furnishing, i.e., applying, the fluid with a predefinable pressure value. A “supply circuit” is to be understood in particular as a circuit of the fluid between the supply pump, a test article, and a fluid tank. A “cooling circuit” is to be understood in particular as a circuit of the fluid between the supply pump, a cooling apparatus, and the fluid tank.

Automatic pressure regulation at the outlet port, in particular inflow pressure regulation and thus an automatic testing sequence for a test article connected at the outlet port, is possible by way of the apparatus according to the present invention and/or the system according to the present invention. The presence of a constant or almost constant quantity of the fluid, having the predefinable and predefined second pressure value, in the cooling circuit can furthermore simultaneously be ensured, thereby continuously making possible sufficient cooling, for example of an injection quantity into the test article, by way of the fluid constituting a coolant. The injection quantity can be made up, entirely or in part, of the fluid that is conveyed to the outlet port and is further processed, in particular heated. The first and/or second pressure value can be adaptable during operation of the apparatus or of the system, for example in order to regulate a desired controlled variable. In a cooling regulation mode, for example, regulation can occur to a constant volume flow of the fluid in the cooling circuit, so as thereby to minimize fluctuations in the volume flow which disrupt measurement operations.

The apparatus according to the present invention is connectable via the outlet port to a pressure regulating valve of some kind, in particular a manual pressure regulating valve, for example of an existing test stand. The apparatus according to the present invention can thus easily be used to retrofit and thereby upgrade existing devices, in particular test stands. One particular advantage is the combination of individual manual adjustability (which is retained) of the manual pressure regulation valve ensuring automatic regulated cooling performance with the second pressure value at every operating point, and automatic pressure regulation to the first pressure value at the outlet port.

The spring-loaded manual pressure regulation valve connectable to the outlet port can take on the function of a safety valve, i.e., a pressure limiting valve.

An “opening pressure value” of a valve, of a check valve, or of a valve device in general is to be understood in particular as a pressure value that must be exceeded by a current pressure value of the fluid in order to open, hold open, and thus pass through the valve, check valve, or valve device that exhibits the said opening pressure value. The fact that a first element is “connected” to a second element is to be understood in particular to mean that the fluid is conveyable, directly and/or via conduit segments, from the first element to the second element and/or vice versa.

A “port,” which includes in particular the outlet port and the cooling apparatus port, is to be understood in particular as a device by way of which the apparatus is connectable to external elements or conduit segments. A “conduit segment” is to be understood as one or more elements, for example tubes, that are configured for (ideally, zero-loss) conveyance of the fluid. Stating that the fluid is capable of being “conveyed” to a specific element is to be understood in particular to mean that in at least one utilization mode of the apparatus or of the system, the fluid is conveyed to the specific element in a context of utilization as intended.

Advantageous embodiments and refinements are evident described herein with reference to the Figures.

In accordance with a preferred refinement of the apparatus according to the present invention, the first valve device and/or the third valve device is configured as at least one electronically or pneumatically controllable proportional valve. As a result, the apparatus can be manufactured and controlled with particularly little technical outlay. Control of the first and/or third valve device can be accomplished by way of a control device of the apparatus but also, alternatively or additionally, with an external control apparatus that can be part of the system according to the present invention.

According to a further preferred refinement, the second valve device is configured as a check valve. The installation of check valves makes possible a limitation, i.e., a diminution, of the size, in particular with reference to Kᵥ value, of proportional valves of the apparatus. A utilization range of proportional valves can thereby be expanded, and/or a greater flow through the proportional valves can be enabled. The Kᵥ value is also referred to as a “flow factor” or “flow coefficient” and is an indication of an achievable throughput of fluid through a valve device, and serves for selection and dimensioning of valve devices. The Kᵥ value can be interpreted as an effective cross section.

According to a further preferred refinement, the fluid conveyed to the controllable third valve device is conveyable to a first return port that is configured for connection of a fluid tank in order to return to the fluid tank the fluid conveyed to the controllable third valve device. As a result, the third valve device can be configured to discharge leakage, and to discharge any inflow via the outlet port into the apparatus according to the present invention. The return flow can occur via an orifice and a tank return line to the fluid tank.

According to a further preferred refinement, the apparatus has a third conduit node having a fifth outlet and having a sixth outlet. The fluid conveyed via the controllable first valve device is conveyable to the third conduit node, the fluid conveyed to the third conduit node being conveyable by way of the fifth outlet to a fourth valve device having a fourth opening pressure value, through which the fluid is conveyable to a second return port that is configured for connection of a fluid tank in order to return to the fluid tank the fluid conveyed to the fourth valve device. The fluid conveyed to the fourth conduit node is conveyable by way of the sixth outlet to the cooling apparatus port. The fluid at the cooling apparatus port is capable of having the predefinable and predefined second pressure value applied to it by way of the fourth valve device; regulation to the second pressure value can occur, which results in a constant or almost constant volume flow through a cooling apparatus connected at the cooling apparatus port.

According to a further preferred refinement, the apparatus has a first pressure sensor that is configured to measure a first current pressure value of the fluid between the introduction port and the first conduit node. A second current pressure value at the cooling apparatus port is measurable by way of a second pressure sensor, with the result that. According to a further preferred refinement, the apparatus has a second pressure sensor that is configured to measure a second current pressure value of the fluid between the third conduit node and the cooling apparatus port. The result is that, advantageously, a minimum pressure value at the cooling apparatus port, which preferably is less than or equal to the predefined second pressure value, can be monitored.

Based on the measured first current pressure value and/or the measured second current pressure value, in particular the first, second, and/or third valve device, but also other valve devices of the apparatus, can be adapted in real time, for example by way of the control device of the system according to the present invention, so that the fluid at the outlet port and at the cooling apparatus port has the first predefinable pressure value and the second predefinable pressure value respectively applied to it.

According to a preferred refinement, the system according to the present invention has a fifth valve device having a manually adjustable fifth opening pressure value, which is connected at the outlet port of the apparatus and through which the fluid to which the predefined first pressure is applied is conveyable to a test article for testing of the test article. For example, if the third valve device is closed, the predefined first pressure value can be furnished at the outlet port by manual adjustment of the fifth valve device; the predefinable and predefined second pressure value at the cooling apparatus port can be maintained by regulation in particular of the first valve device, for example by way of a control device, thus bringing about a constant or almost constant volume flow of the fluid through the cooling apparatus port.

According to a further preferred refinement, the system according to the present invention includes a second pump apparatus by way of which the fluid having a first introduction pressure value is conveyable via the fifth valve device to the test article for testing of the test article, the first introduction pressure value being greater than a second introduction pressure value which is the maximum that can be applied to the fluid by way of the first pump apparatus. For example, the second pump apparatus is configured to apply to the fluid the first introduction pressure value of six thousand kilopascals, while the first pump apparatus is configured to apply to the fluid a second introduction pressure value of between zero and six hundred kilopascals, i.e., at most a second introduction pressure value of six hundred kilopascals.

### BRIEF DESCRIPTION OF THE DRAWINGS

The present invention is explained in further detail below with reference to the exemplifying embodiments depicted in the Figures.

FIG. 1 is a schematic block diagram of a system according to the present invention in accordance with a first embodiment of the present invention, and of an apparatus according to the present invention in accordance with a second embodiment of the present invention.

FIG. 2 is a schematic side view of an apparatus according to the present invention in accordance with a third embodiment of the present invention.

FIG. 3 is a schematic perspective view of the apparatus in accordance with the third embodiment of the present invention.

FIG. 4 is a schematic plan view of the apparatus in accordance with the third embodiment of the present invention.

In the Figures, identical or functionally identical elements and apparatuses are labeled with the same reference characters unless otherwise indicated.

### DETAILED DESCRIPTION OF EXAMPLE EMBODIMENTS

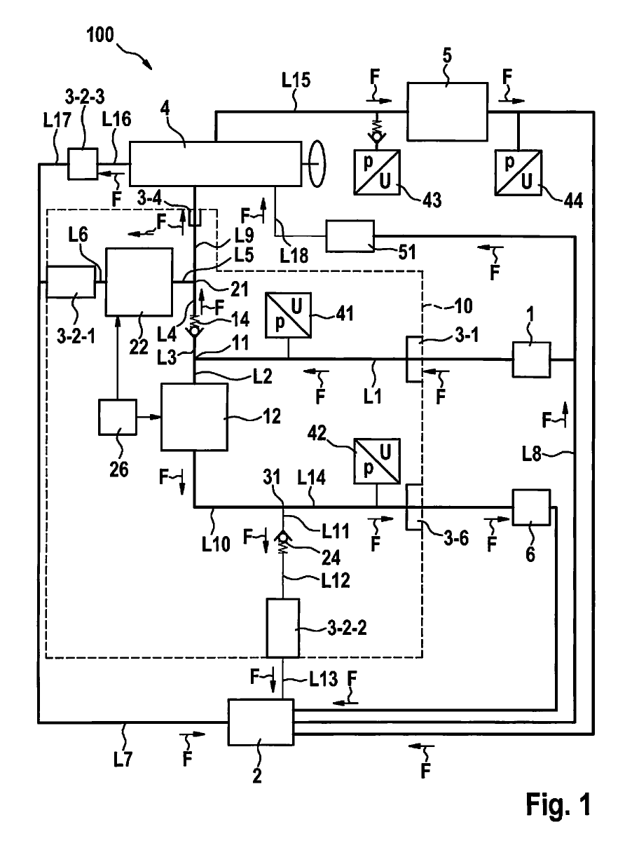

FIG. 1 is a schematic block diagram of a system 100 for automatic application to a cooled fluid F of a first predefinable pressure value for output at an outlet port 3-4, in accordance with a first embodiment of the present invention; and of an apparatus 10 for automatic simultaneous application to a fluid F of a first predefinable pressure value for output at an outlet port 3-4 and a second predefinable pressure value for output at a cooling apparatus port 3-6, in accordance with a second embodiment of the present invention.

In accordance with the first embodiment, system 100 according to the present invention has a controllable first pump apparatus 1 that is connectable, for the introduction of fluid F from a fluid tank 2, to an introduction port 3-1 of an apparatus 10 according to the present invention in accordance with the second embodiment of the present invention. In accordance with the first and second embodiment, fluid F is an oil. First pump apparatus 1 is configured as a gear pump that has a power output of 0.75 kW, the oil constituting fluid F being furnishable at introduction port 3-1 with an introduction pressure value of between zero and eight hundred kilopascals at a volume flow of 22.3 liters per minute for operation at 50 Hertz, or at a volume flow of 26.8 liters per minute for operation at 60 Hertz.

The oil constituting fluid F that is introduced into introduction port 3-1 is conveyable via a first conduit segment L1 to a first conduit node 11, no portion of fluid F being permanently diverted between introduction port 3-1 and first conduit node 11. Located between first conduit node 11 and introduction port 3-1 is a first pressure sensor 41 by way of which a current pressure value of fluid F between first conduit node 11 and introduction port 3-1 is measurable. In other words, the introduction pressure value of first pump apparatus 1 is measurable by way of pressure sensor 41.

First conduit node 11 has a first outlet and a second outlet to which the fluid conveyed from introduction port 3-1 to first conduit node 11 is conveyable. By way of the first outlet, fluid F is conveyable via a second conduit segment L2 to a controllable first valve device having an adjustable first opening pressure value. First valve device 12 is an electronically controllable proportional valve that is controllable by way of a control device 26 of system 100 according to the present invention. Control apparatus 26 can also be configured as part of apparatus 10 according to the present invention. Control apparatus 26 is configured to predefine, preferably also to adapt, the first and the second predefinable pressure value.

Fluid F is conveyable, at least in part, via first valve device 12 to a cooling apparatus port 3-6 of apparatus 10. A cooling apparatus 6 of system 100 according to the present invention is connectable to cooling apparatus port 6, the test article and/or an injection quantity into the test article being coolable by way of said apparatus, in which context fluid F that is conveyed at least in part to cooling apparatus port 3-6 functions as a coolant.

The second outlet of first conduit node 11 is connected via a third conduit segment L3 to a second valve device 14 that is configured as a check valve having a second opening pressure value of 200 kilopascals. Second valve device 14 configured as a check valve on the one hand ensures that due to a relatively high differential pressure at first valve device 12 configured as a proportional valve, a sufficiently large volume flow of the fluid can flow in the cooling circuit, i.e., toward cooling apparatus port 3-6 and through cooling apparatus port 3-6. The pressure-side outlet of second valve device 14 configured as a check valve is connected via a fourth conduit segment L4 to a second conduit node 21.

Second conduit node 21 has a third outlet and a fourth outlet to which fluid F conveyed to second conduit node 21 is conveyable. A controllable third valve device 22 having an adjustable third opening pressure value is connected to the third outlet via a fifth conduit segment L5. Third valve device 22 is configured as an electronically controllable proportional valve and, for example, is likewise controllable by way of control apparatus 26. A first return port 3-2-1, which is connected by way of a seventh conduit segment L7 to a fluid tank 2 of system 100 according to the present invention, is configured at the outlet side of third valve device 22 via a sixth conduit segment L6. Fluid tank 2 is configured to store the fluid and to furnish the fluid, via an eighth conduit segment L8, for pumping by way of first pumping apparatus 1.

The fourth outlet of second conduit node 21 is connected via a ninth conduit segment L9 to outlet port 3-4 of apparatus 10 according to the present invention.

A third conduit node 31, which has a fifth outlet and a sixth outlet, is connected at the outlet side of first valve device 12 via a tenth conduit segment L10. A fourth valve device 24, having a fourth opening pressure value, is connected at the fifth outlet via an eleventh conduit segment L11. Fourth valve device 24 is configured as a check valve having a fourth opening pressure value of 35 kilopascals. Fourth valve device 24 thus makes it possible to apply to fluid F the predefinable and predefined second pressure value, for example twenty kilopascals, in the cooling circuit, i.e., in particular at cooling apparatus port 3-6, the consequence of which is a constant or almost constant volume flow, in the present example nine liters per minute, through cooling apparatus 6. Fourth valve device 24 is connected via a twelfth conduit segment L12 to a second return port 3-2-2 that in turn is connected via a thirteenth conduit segment L13 to fluid tank 2.

A second pressure sensor 42, for measuring a second current pressure value of oil F between third conduit node 31 and cooling apparatus port 3-6, is disposed at the sixth outlet of third conduit node 31 via a fourteenth conduit segment L14. In other words, before valve device 14 (in the flow direction of fluid F), at least a portion of fluid F is diverted via first valve device 12 configured as a proportional valve, in order to supply cooling apparatus 6; after first valve device 12 (in the flow direction of the fluid), the conduit layout branches into the supply to cooling apparatus 6 via cooling apparatus port 3-6, and back into fluid tank 2 via fourth valve device 24 configured as a check valve. The fluid at cooling apparatus port 3-6 is regulated to the predefinable and predefined second pressure value based on second pressure sensor 42.

Outlet port 3-4 is connected to a manually actuatable fifth valve device 4 of system 100 according to the present invention, having a manually adjustable fifth opening pressure value. Fifth valve device 4 functions as a 600-kilopascal overpressure valve. A test article 5, in particular an injection pump, for example a high-pressure pump, is connected to an outlet side of fifth valve device 4 for testing test article 5 at the predefinable and predefined first pressure value. A third pressure sensor 43 for measuring a third current pressure value is disposed, between fifth valve device 4 and test article 5, at a fifteenth conduit segment L15 that connects fifth valve device 4 to test article 5. A fourth pressure sensor 44 for measuring a fourth current pressure value of fluid F is furthermore disposed behind test article 5 (in the flow direction of fluid F) for testing of test article 5.

A second pump apparatus 51 of system 100 is connected to fifth valve device 4, fluid F being conveyable by way of said apparatus out of fluid tank 2 to fifth valve device 4. Second pump apparatus 51 is configured as a gear pump that has a power output of 0.75 kilowatts, the oil constituting fluid F and having the introduction pressure value of six thousand kilopascals being conveyable to fifth valve device 4 at a volume flow of 1.4 liters per minute for operation at 50 Hertz, and at a volume flow of 1.7 liters per minute for operation at 60 Hertz.

Fifth valve device 4 is configured in such a way that in a first valve position of fifth valve device 4, fluid F introduced from first pump apparatus 1 into apparatus 10 is returnable not to the test article, but instead to fluid tank 2 via a third return port 3-2-3 that has fifth valve device 4. In the first valve position the fluid conveyed from second pump apparatus 51 to fifth valve device 4 is furthermore conveyable to test article 4 at the introduction pressure value of six thousand kilopascals. In a second valve position of fifth valve device 4, fluid F can be furnished to test article 5 both by way of first pump apparatus 1 and by way of second pump apparatus 51.

Third valve device 22 can be completely closed, for example under the control of control device 26, in order to achieve a comparatively high predefined first pressure value at outlet port 3-4. Regulated closing of first valve device 12 thus allows fluid F at outlet port 3-4 to have the predefined first pressure value applied to it. For that purpose, first valve device 12 can be closed until second pressure sensor 42 recognizes that the pressure value has fallen below the second predefinable and predefined value that is greater than or equal to the minimum pressure value required for the use of fluid F as a coolant in cooling apparatus 6, and/or that the flow rate has fallen below a minimum value. In the present example the minimum pressure value is 20 kilopascals.

Given a comparatively low predefined first pressure value and very little or no uptake of fluid F by test article 5, any leakage at second valve device 14 configured as a check valve can be returned to fluid tank 2 via third valve device 22. In the same fashion, any volume flow that is carried to fifth valve device 4 by way of second pump apparatus 51 can be conveyed via third valve device 22 entirely or in part to fluid tank 2 and can thus be returned. In the present example, fluid F at outlet port 3-4 can thus automatically have the predefined first pressure value, having pressure values between 10 and 600 kilopascals, applied to it by applying control to first valve device 12 and to third valve device 22, in particular based on the measured current first to third pressure values.

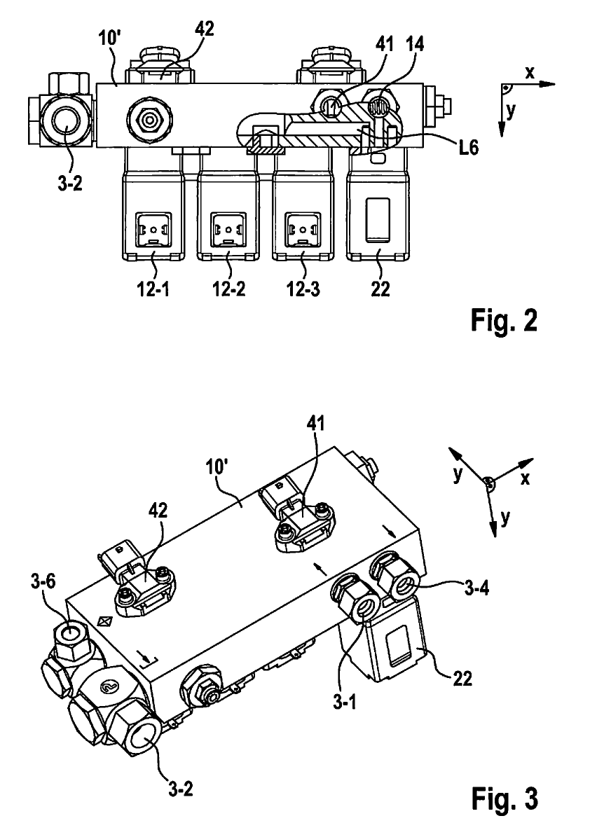

FIG. 2 is a schematic side view of an apparatus 10′ for automatic simultaneous application to a fluid of a first predefinable pressure value for output at an outlet port, and of a second predefinable pressure value for output at a cooling apparatus port, in accordance with a third embodiment of the present invention. For better comprehension of FIGS. 2 to 4, an orthonormal coordinate system having coordinate axes x, y, and z is defined, the side view of FIG. 2 lying in the x-y plane.

Apparatus 10′ is a variant of apparatus 10, which differs from the latter in that first valve device 12-1, 12-2, 12-3 of apparatus 10′ is configured as three individually embodied, separately controllable proportional valves 12-1, 12-2, 12-3; and that first return port 3-2-1 and second return port 3-2-3 are configured as one and the same common return port 3-2.

Apparatus 10′ is configured in such a way that with correct installation, first and third valve devices 12-1, 12-2, 12-3, 22 configured as proportional valves are disposed, proceeding from apparatus 10′, in the direction in which the earth's gravity acts. It is thereby possible to avoid air inclusions in the proportional valves, which can cause resonance vibrations in the proportional valves.

FIG. 3 is a schematic perspective view of apparatus 10′ in accordance with the third embodiment of the present invention.

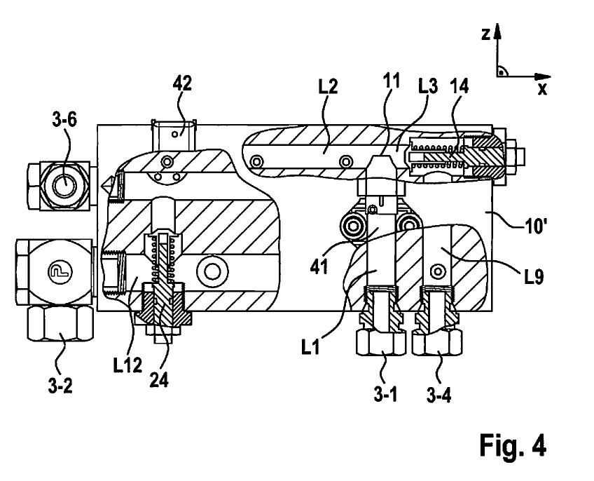

FIG. 4 is a schematic plan view of apparatus 10′ in accordance with the third embodiment of the present invention. The plan view of FIG. 2 lies in the x-z plane.

Although the present invention has been described above with reference to preferred exemplifying embodiments, it is not limited thereto but is instead modifiable in a wide variety of ways. In particular, the present invention can be changed or modified in a multiplicity of ways without deviating from the essence of the present invention.

For example, second and/or fourth valve device 14, 24 can also be configured with manual or automatic adjustability of the second opening pressure value. Control device 26 can be configured for automatic adjustment of the second opening pressure value based on a pressure difference between a current pressure value measured by way of third and/or fourth pressure sensor 43, 44 and a current pressure value measured by way of first pressure sensor 41. It can be advantageous if the opening pressure value of second valve device 14 is set to be greater than the predefined second pressure value.

1-11. (canceled)

12. An apparatus for application of pressure to a fluid, the fluid being capable of having applied to it a first predefinable pressure value for output at an outlet port, and a second predefinable pressure value for output at a cooling apparatus port, the apparatus comprising:
an introduction port for introducing the fluid into the apparatus;
the cooling apparatus port;
the outlet port;
a first conduit node that has a first outlet and a second outlet, the fluid introduced at the introduction port being conveyable by way of the first outlet to a controllable first valve device having an adjustable first opening pressure value, and being conveyable by way of the second outlet to a second valve device having a second opening pressure value, the fluid being conveyable via the controllable first valve device to the cooling apparatus port, the fluid being conveyable via the second valve device to a second conduit node having a third outlet and a fourth outlet;
wherein the fluid conveyed to the second conduit node is conveyable by way of the third outlet of the second conduit node to a controllable third valve device having an adjustable third opening pressure value, the fluid conveyed to the second conduit node is conveyable by way of the fourth outlet of the second conduit node to the outlet port, and the first valve device and the third valve device are automatically controllable for simultaneous application to the fluid of the first predefinable pressure value for output at the outlet port and of the second predefinable pressure value for output at the cooling apparatus port.

13. The apparatus as recited in claim 12, wherein at least one of the first valve device and the third valve device is configured as at least one electronically or pneumatically controllable proportional valve.

14. The apparatus as recited in claim 12, wherein the second valve device is a check valve.

15. The apparatus as recited in claim 12, wherein the fluid conveyed to the controllable third valve device is conveyable to a first return port that is configured for connection of a fluid tank to return to the fluid tank the fluid conveyed to the controllable third valve device.

16. The apparatus as recited in claim 15, further comprising:
a third conduit node to which the fluid conveyed via the controllable first valve device is conveyable and which has a fifth outlet and a sixth outlet, wherein the fluid conveyed to the third conduit node being conveyable by way of the fifth outlet to a fourth valve device having a fourth opening pressure value, through which the fluid is conveyable to a second return port that is configured for connection of a fluid tank to return to the fluid tank the fluid conveyed to the fourth valve device, and wherein the fluid conveyed to the third conduit node is conveyable by way of the sixth outlet to the cooling apparatus port.

17. The apparatus as recited in claim 16, further comprising:
a first pressure sensor that is configured to measure a first current pressure value of the fluid between the introduction port and the first conduit node.

18. The apparatus as recited in claim 17, further comprising:
a second pressure sensor that is configured to measure a second current pressure value of the fluid between the third conduit node and the cooling apparatus port.

19. A system for application of pressure to a fluid, the fluid being capable of having applied to it a first predefinable pressure value for output at an outlet port, the system comprising:
an apparatus for application of pressure to a fluid, the fluid being capable of having applied to it a first predefinable pressure value for output at an outlet port, and a second predefinable pressure value for output at a cooling apparatus port, the apparatus including an introduction port for introducing the fluid into the apparatus, the cooling apparatus port, the outlet port, a first conduit node that has a first outlet and a second outlet, the fluid introduced at the introduction port being conveyable by way of the first outlet to a controllable first valve device having an adjustable first opening pressure value, and being conveyable by way of the second outlet to a second valve device having a second opening pressure value, the fluid being conveyable via the controllable first valve device to the cooling apparatus port, the fluid being conveyable via the second valve device to a second conduit node having a third outlet and a fourth outlet, wherein the fluid conveyed to the second conduit node is conveyable by way of the third outlet of the second conduit node to a controllable third valve device having an adjustable third opening pressure value, the fluid conveyed to the second conduit node is conveyable by way of the fourth outlet of the second conduit node to the outlet port, and the first valve device and the third valve device are automatically controllable for simultaneous application to the fluid of the first predefinable pressure value for output at the outlet port and of the second predefinable pressure value for output at the cooling apparatus port;
a controllable first pump apparatus that is connected to the introduction port of the apparatus to introduce the fluid;
a fluid tank for storing the fluid, which is connected to the apparatus to receive fluid to be returned from the apparatus to the fluid tank; and
a cooling apparatus connected at the cooling apparatus port of the apparatus, in which the fluid functions as a coolant and by way of which the fluid is returnable to the fluid tank.

20. The system as recited in claim 19, further comprising:
a fifth valve device having a manually adjustable fifth opening pressure value, which is connected at the outlet port of the apparatus and through which the fluid to which the predefined first pressure value is applied is conveyable to a test article for testing of the test article.

21. The system as recited in claim 20, further comprising:
a second pump apparatus by way of which the fluid having a first introduction pressure value is conveyable via the fifth valve device to the test article for testing of the test article, the first introduction pressure value being greater than a second introduction pressure value which is the maximum that can be applied to the fluid by way of the first pump apparatus.
